(19) United States
(12) Patent Application Publication
(10) Pub. No.: US 2008/0023454 A1
(43) Pub. Date: Jan. 31, 2008

(54) Workpiece positioning structure of laser machine

(75) Inventors: Chung-Ting Chang, Hsi Chih City (TW); Wen-Lung Liang, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/492,899

(22) Filed: Jul. 26, 2006

(51) Int. Cl. B23K 26/00

(52) U.S. Cl. 219/121.67; 219/121.6

(57) ABSTRACT

A workpiece positioning structure of a laser-cutting/carving machine for using on a working platform of the machine, comprises a fixing seat, at least a flexible connecting rod and an indicator to provide laser light spot, wherein one end of the flexible connecting rod is disposed on the fixing seat, the indicator to provide laser light spot is detachable connected to the connecting rod, when adjusting the connecting rod, the laser spot emitted from the indicator can be projected onto a corresponding position on the working platform.

### BACKGROUND OF THE INVENTION

1. Field of the Invention

The present invention is related to a workpiece positioning structure of a laser-cutting/carving machine, and more particularly to a positioning structure that can indicate a precise position for a workpiece, is convenient in use and adjustment, and applicable for processing a workpiece of soft material on the laser-cutting/carving machine.

2. Description of the Prior Art

The basic principle of a laser-processing machine is to guide and focus a light beam output by lasing on a surface of a carved workpiece. The light beam after focusing is absorbed by the workpiece to suddenly elevate temperature and make aerification of the latter, the surface of the article thereby is dented, thus an object of carving and cutting can be achieved.

A conventional laser-processing machine (such as a cutting machine or a carving machine) must have a workpiece put in position before cutting and carving in favor of executing carving and cutting. The way of positioning used generally, in addition to positioning by eye viewing, is by means of a ruler.

However, the way of positioning by eye viewing only suits rougher carving and cutting operations. For processing of larger accuracy and preciseness, a user will use measuring tool such as a ruler for positioning. Normal workpieces of hard material such as acryl, plates and blocks etc. can obtain the object of using a ruler for positioning, but for those workpieces of soft material such as paper, cloth etc., accurate positioning is unable acquired by using a ruler, and error is easily induced. Such inaccurate cutting is resulted to affect the quality of products, even waste material can be created. Besides, in using a ruler for positioning, the speed of positioning is very slow, this may affect the speed of working of the user.

### SUMMARY OF THE INVENTION

The primary objective of the present invention is to provide a workpiece positioning structure of a laser-cutting/carving machine, which can indicate a precise position for the workpiece, and is convenient in use and adjustment.

To reach the above objective, the workpiece positioning structure according to the present invention comprises a fixing seat, at least a flexible connecting rod and an indicator to provide laser light spot; wherein one end of the flexible connecting rod is disposed on the fixing seat, the indicator to provide laser light spot is detachable connected to the connecting rod, and when adjusting the connecting rod at will, the laser spot emitted from the indicator can be projected onto a corresponding position on the working platform.

The other features and advantages of the present invention will be apparent after reading the detailed description of the preferred embodiment hereinafter in reference to the accompanying drawings.

### BRIEF DESCRIPTION OF THE DRAWINGS

FIG. 1 is a perspective view of an embodiment of the workpiece positioning structure of the present invention;

FIG. 2 is another perspective view of the embodiment of the workpiece positioning structure of the present invention;

FIG. 3 is a perspective view showing the workpiece positioning structure of the present invention being mounted on a machine in use; and

FIG. 4 is a perspective schematic view showing the status of using the workpiece positioning structure of the present invention.

### DETAILED DESCRIPTION OF THE PREFERRED EMBODIMENT

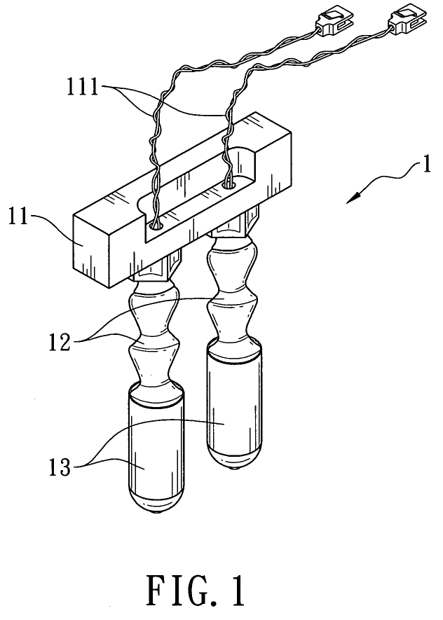

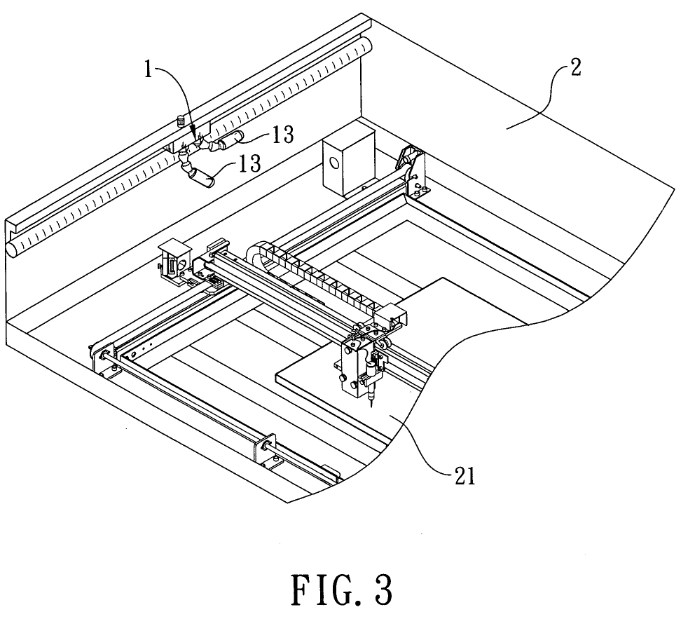

Referring to FIGS. 1-3 showing an embodiment of the workpiece positioning structure 1 of a laser-cutting/carving machine 2 of the present invention. The structure 1 is for using on a working platform 21 of the machine 2, comprising a fixing seat 11, at least a flexible connecting rod 12 and an indicator 13 to provide laser light spot.

The fixing seat 11 is connected onto the working platform 21 of the machine 2, and the fixing seat 11 is provided thereon with a power supplying means 111 to supply electric power for the indicator 13.

One end of each of the at least one flexible connecting rod 12 is disposed on the fixing seat 11. The number of the connecting rods 12 in this embodiment is two (for example). Both of them are disposed on the fixing seat 11.

The indicator 13 to provide laser light spot is detachably connected to the connecting rods 12; when adjusting the connecting rods 12, the laser spot emitted from the indicator 13 can be projected onto a precise position on the working platform 21.

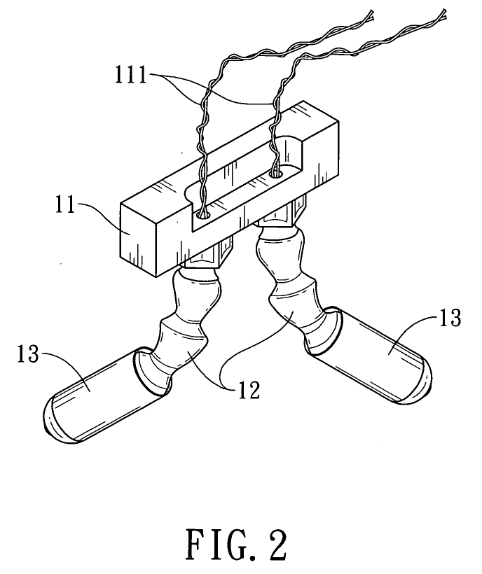

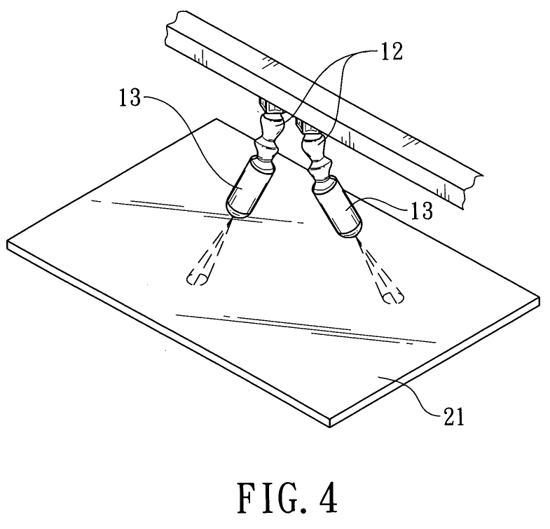

In use, referring to FIGS. 2-4, firstly the workpiece positioning structure 1 having been assembled is disposed at one of various positions on the working platform 21 of the machine 2 according to requirement. When in carving and cutting operation, a user can adjust the connecting rods 12 at will to render the laser spot emitted from the indicator 13 on the connecting rods 12 to be projected onto a precise position on the working platform 21. The workpiece can thus be fast and accurately put in the position where the laser spot is to irradiate at. This can increase the effect of positioning a workpiece of soft material.

Therefore, the present invention has the following advantages:
1. The present invention takes advantage of the design of laser spot positioning to make a user fast and surely discriminate a position and place a workpiece immediately in position. It is very convenient and effective.
2. The workpiece positioning structure of a laser-cutting/carving machine of the present invention takes advantage of the design of a flexible connecting rod to acquire a wide angular rotating range for projection of laser spot, and the structure is simple, convenient in use and adjustment.

In conclusion, according to the above statement and drawings attached, the present invention surely can reach the expected objective to provide a workpiece positioning structure of a laser-cutting/carving machine, which is simple, and convenient in use and adjustment.

The embodiment is only for illustrating the present invention, and not for giving any limitation to the scope of the present invention. It will be apparent to those skilled in this art that various equivalent modifications or changes could be made without departing from the spirit of this invention.

1. A workpiece positioning structure of a laser-cutting/carving machine, for using on a working platform of said machine, comprising:
a fixing seat;
at least one flexible connecting rod of which one end is disposed on said fixing seat; and
an indicator to provide laser spot, said indicator is connected to said connecting rod, when adjusting said connecting rod, laser spot emitted from said indicator is projected onto a corresponding position on said working platform.

2. The workpiece positioning structure of a laser-cutting/carving machine as in claim 1, wherein said workpiece positioning structure has two of said flexible connecting rods.

3. The workpiece positioning structure of a laser-cutting/carving machine as in claim 1, wherein said fixing seat is provided thereon with a power supplying means to supply electric power for said indicator.

4. The workpiece positioning structure of a laser-cutting/carving machine as in claim 1, wherein said indicator is detachable connected to said connecting rods.
